(19) United States
(12) Patent Application Publication
(10) Pub. No.: US 2007/0090687 A1
(43) Pub. Date: Apr. 26, 2007

(54) Method for providing predetermined toe angle of wheels of drive axle assembly

(76) Inventors: David Joseph Young, Delta, OH (US); Brian Vitales Knapke, Toledo, OH (US)

Correspondence Address: BERENATO, WHITE & STAVISH, 6550 ROCK SPRING DRIVE, SUITE 240, BETHESDA, MD, 20817, US

(21) Appl. No.: 11/583,133

(22) Filed: Oct. 19, 2006

Related U.S. Application Data
(60) Provisional application No. 60/728,328, filed on Oct. 20, 2005.

(51) Int. Cl. B60B 37/00

(52) U.S. Cl. 301/124.1

(57) ABSTRACT

A drive axle assembly comprises an axle tube, a hub assembly mounted to an outer end of the axle tube and carrier member mounted to an inner end thereof. The axle tube is mounted to the hub assembly and the carrier member so that a central axis of the hub assembly intersects a transverse axis of the carrier member at an angle to substantially equal to a predetermined toe angle of a wheel of the drive axle assembly.

### CROSS-REFERENCE TO RELATED APPLICATION

This Application claims the benefit under 35 U.S.C. 119(e) of U.S. Provisional Application No. 60/728,328 filed on Oct. 20, 2005 by David J. Young.

### BACKGROUND OF THE INVENTION

1. Field of the Invention

The present invention relates to drive axle assemblies of motor vehicles and methods for manufacturing thereof in general, and in particular to a drive axle assembly providing a predetermined toe angle of wheels of the drive axle assembly and a method for providing the predetermined toe angle of the wheels.

2. Description of the Prior Art

Rear suspension systems have been constructed to control the attitude of the rear wheels in order to provide particular handling characteristics of the motor vehicle, for example roll understeer or roll oversteer, as well as to provide a soft ride free from road vibrations. The handling and ride (dynamic) characteristics of a motor vehicle depend on many vehicles parameters including a toe angle of rear wheels.

Toe-in and toe-out of vehicle wheels are defined as the distance between the front edges of the wheels of a vehicle being shorter and longer respectively than the distance between the rear edges of those wheels. Typically, a toe-in setting of the axle assembly is adjusted to provide a predetermined toe angle according to manufacturer's specification.

Wheels of a motor vehicle, especially rear wheels, are subjected to back-and-forth movements when moving over recesses and projections on the road, and transverse movements due to either turning action of the vehicle, or travel over such recesses and projections. As for the back-and-forth movements, when the rear wheel moves over the recesses and projections or onto obstructions such as curbs, riding comfort is reduced unless smooth displacement in the movements of the rear wheel is assured. On the other hand, fluctuating movements of the rear wheel in toe-in and toe-out directions are undesirable, and if so moved, the vehicle body will be vibrated to thereby reduce riding comfort. Since the wheel toe angle influences the steering stability and riding qualities of a vehicle and has a direct effect on tire wear, it is important to properly set the toe-in on an axle assembly line before the axle is installed in the vehicle.

Vehicle wheels are typically adjusted to a toe-in position. Vehicle wheel toe-in settings have been performed by a variety of methods. Typically, toe-in settings are performed subsequent to manufacturing and assembling the vehicle axle assembly. Currently, toe-in settings are performed subsequent to manufacturing and assembling the vehicle axle assembly. Process of adjusting of the toe-in settings of the axle assembly after its assembling is laborious and time consuming.

Therefore, there is a need for a drive axle assembly providing a predetermined toe angle according to manufacturer's specification prior to assembling thereof and a method for manufacturing the same that is simple and inexpensive, and would provide a predetermined toe angle in accordance with manufacturer's specification.

### SUMMARY OF THE INVENTION

Therefore, the present invention provides a novel drive axle assembly providing a predetermined toe angle of wheels of the drive axle assembly according to manufacturer's specification and a novel method for providing the predetermined toe angle of the wheels.

According to a first exemplary embodiment of the present invention, a drive axle assembly comprises a wheel, an axle tube having a central axis and a tube mounting surface adjacent an outer end of the axle tube, and a hub assembly having a central axis and including a rotatable hub member and a non-rotatable hub member. The non-rotatable hub member has a hub mounting surface engaging the tube mounting surface of the axle tube. Furthermore, one of the tube mounting surface and the hub mounting surface is oriented at an angle to the corresponding central axis substantially equal to a predetermined toe angle of the wheel. A method for providing a predetermined toe angle of a wheel of a drive axle assembly in a motor vehicle, according to the first exemplary embodiment of the present invention, comprises the steps of: providing an axle tube having a central axis and a tube mounting surface adjacent an outer end of the axle tube, providing a hub assembly having a central axis and including a rotatable hub member and a non-rotatable hub member having a hub mounting surface, determining a predetermined toe angle of a wheel of the drive axle assembly driven by the rotatable hub member of the hub assembly, forming one of the tube mounting surface and the hub mounting surface so as to be oriented at an angle to the corresponding central axis substantially equal to the predetermined toe angle of said wheel, and attaching the non-rotatable hub member to the outer end of the axle tube by connecting the tube mounting surface to the hub mounting surface.

According to a second exemplary embodiment of the present invention, a drive axle assembly comprises a hollow carrier member having a transverse axis and a trunnion having a continuous inner surface defining a central axis thereof, and an axle tube having a central axis and a carrier mounting portion provided at an inner end of the axle tube. The carrier mounting portion has a continuous outer surface defining a central axis thereof. The outer surface of the carrier mounting portion engages the inner surface of the trunnion. Moreover, one of the outer surface and the inner surface formed so that the central axis of the axle tube intersects the transverse axis of the carrier member at an angle substantially equal to a predetermined toe angle of a wheel of the drive axle assembly. A method for providing a predetermined toe angle of a wheel of a drive axle assembly in a motor vehicle, according to the second exemplary embodiment of the present invention, comprises the steps of: providing a hollow carrier member having a transverse axis and a trunnion, providing an axle tube having a central axis and a carrier mounting portion provided at an inner end thereof, determining a predetermined toe angle of a wheel of the drive axle assembly, and coupling the carrier mounting portion to the trunnion so that the central axis of the axle tube intersects the transverse axis of the carrier member at the predetermined toe angle.

According to a third exemplary embodiment of the present invention, a drive axle assembly comprises an axle tube having inner and outer ends, a hollow carrier member mounted to the inner end of the axle tube, and a hub assembly mounted to the outer end of the axle tube for rotatably supporting a wheel. The axle tube is non-linear so that a central axis of the outer end of the axle tube intersects a central axis of the inner end thereof at an angle substantially equal to a predetermined toe angle of the wheel. A method for providing a predetermined toe angle of a wheel of a drive axle assembly in a motor vehicle, according to the third exemplary embodiment of the present invention, comprises the steps of: providing an axle tube having inner and outer ends, determining a predetermined toe angle of a wheel of the drive axle assembly, bending the axle tube so that a central axis of the outer end intersects a central axis of the inner end at an angle substantially equal to a predetermined toe angle of the wheel, providing a hollow carrier member having a transverse axis, and mounting the inner end of the axle tube to the carrier member.

Therefore, the present invention provides a novel drive axle assembly and method for assembling thereof, which provides a predetermined toe angle of drive wheels of a motor vehicle in a way that is accurate, simple, cost effective, and substantially reduces time and labor expenses.

### BRIEF DESCRIPTION OF THE DRAWINGS

Objects and advantages of the invention will become apparent from a study of the following specification when viewed in light of the accompanying drawings, wherein:

FIG. 1 is a partial sectional view of a drive axle assembly of a motor vehicle according to a first exemplary embodiment of the present invention;

FIG. 2 is an enlarged partial sectional view of a distal end of the drive axle assembly of FIG. 1;

FIG. 3 is a partial sectional view of a drive axle assembly of a motor vehicle according to a second exemplary embodiment of the present invention;

FIG. 4 is an enlarged partial sectional view of a distal end of the drive axle assembly of FIG. 3;

FIG. 5 is a partial sectional view of a drive axle assembly of a motor vehicle according to a third exemplary embodiment of the present invention;

FIG. 6 is a partial exploded view of the drive axle assembly according to the third exemplary embodiment of the present invention;

FIG. 7 is a partial sectional view of a drive axle assembly of a motor vehicle according to a fourth exemplary embodiment of the present invention;

FIG. 8 is a partial exploded view of the drive axle assembly according to the fourth exemplary embodiment of the present invention;

FIG. 9 is a partial sectional view of a drive axle of the motor vehicle according to a fifth exemplary embodiment of the present invention.

FIG. 10 is a partial exploded view of the drive axle assembly according to the fifth exemplary embodiment of the present invention.

### DESCRIPTION OF PREFERRED EMBODIMENTS

The preferred embodiments of the present invention will now be described with the reference to accompanying drawings.

For purposes of the following description, certain terminology is used in the following description for convenience only and is not limiting. The words such as “outer” and “inner”, “inwardly” and “outwardly”, “left” and “right” designate directions in the drawings to which reference is made. The terminology includes the words specifically mentioned above, derivatives thereof and words of similar import. Additionally, the word “a”, as used in the claims, means “at least one”.

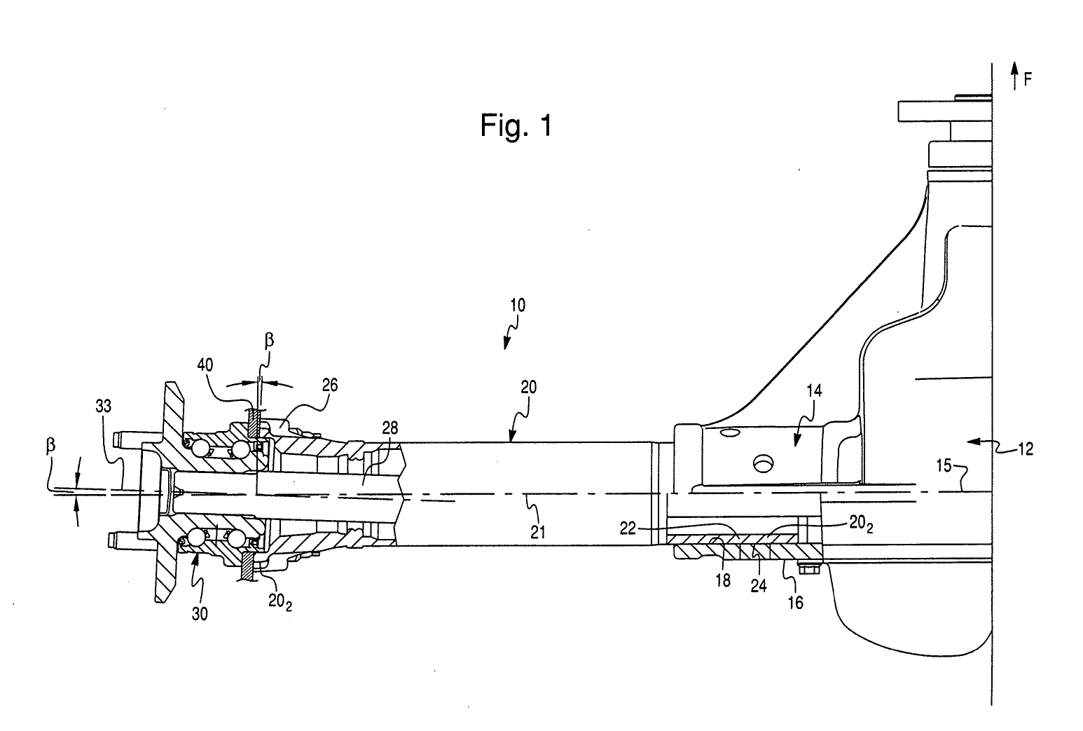

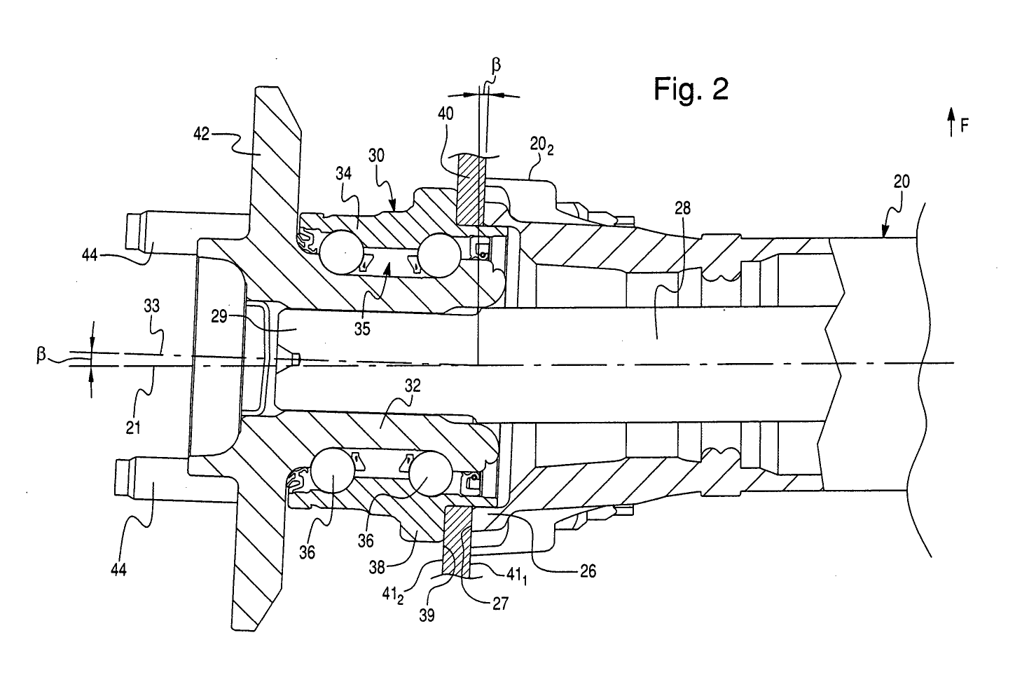

FIGS. 1 and 2 of the drawings illustrate a first exemplary embodiment of a non-steering drive axle assembly, generally depicted by the reference character 10, of a motor vehicle (not shown), such as a rear solid drive axle. As used herein, the words “front” and “rear” in the following description are referred with respect to a driving direction of the motor vehicle, as indicated in the accompanying drawing FIG. 1 by an arrow F. It should be noted that the drive axle assembly 10 is illustrated in FIGS. 1 and 2 in an assembled condition with no vertical or horizontal load, such as vehicle weight, traction force, etc., applied thereto. The drive axle assembly 10 comprises a hollow carrier member 12 defining a transverse axis 15 and provided with a pair of trunnions 14 (or mounting sleeves) (only one trunnion is shown in FIG. 1) axially outwardly extending from the carrier member 12 along the transverse axis 15. Preferably, the each of the trunnions 14 has a generally cylindrical outer peripheral surface 16 substantially coaxial to the transverse axis 15, and a substantially cylindrical inner peripheral surface 18 defining a mounting bore therein. The mounting bore 18 of the trunnion 14 is substantially coaxial to the transverse axis 15. The carrier member 12 houses a differential mechanism (not shown) therewithin.

The drive axle assembly 10 also comprises a pair of hollow axle tubes 20 (only one axle tubes is shown in FIG. 1) axially outwardly extending from the trunnions 14 of the carrier member 12. Each of the axle tube 20 has a central axis 21 extending between inner and outer ends, 20₁, and 20₂, respectively, of the axle tube 20. In the first exemplary embodiment of the present invention, the central axis 21 of the axle tube 20 is substantially coaxial to the transverse axis 15 of the carrier member 12. The drive axle assembly 10 further comprises a pair of axle shafts 28 (only one axle shaft is shown in FIG. 1) axially outwardly extending from the carrier member 12 and through the axle tubes 20, and a pair of hub assemblies 30 (only one shown in FIG. 1) each coupled to the outer end 20₂ of the corresponding axle tube 20. Each of the axle tubes 20 is coupled with the corresponding annular trunnion 14 by any appropriate means known in the art. The axle shafts 28 may then be inserted through the axle tubes 20 into driving engagement with side gears (not shown) of the differential mechanism housed in the carrier member 12. Moreover, the axle tube 20 has a carrier mounting portion 22 at the inner end 20₁ thereof coupled to the trunnion 14 of the carrier member 12, and a hub mounting portion 26 at the outer end 20₂ thereof coupled to the hub assembly 30. Moreover, the hub mounting portion 26 of the axle tube 20 has a tube mounting surface 27 facing the hub assembly 30.

The hub assembly 30 includes a rotatable hub member 32 drivingly coupled to an outboard end 29 of the axle shaft 28, and a non-rotatable (stationary) hub member 34 non-rotatably coupled to the hub mounting portion 26 of the axle tube 20. The rotatable hub member 32 is rotatably supported by the non-rotatable hub member 34 through a bearing assembly 35 for rotation about a central axis 33 of the hub assemblies 30. The bearing assembly 35 includes an inner race defined by the rotatable hub member 32 of the hub assemblies 30, an outer race defined by the non-rotatable hub member 34 thereof, and a plurality of rolling elements 36. The non-rotatable hub member 34 of the hub assemblies 30 is further provided with a mounting flange 38. The mounting flange 38 has a hub mounting surface 39 facing the tube mounting surface 27 of the hub mounting portion 26 of the axle tube 20. The mounting surface 39 is formed (machined) to be substantially orthogonal to the central axis 33 of the hub assembly 30. The rotatable hub member 32 of the hub assembly 30 has wheel a mounting flange 42 having a series of wheel mounting studs 44 installed therein for mounting a non-steering drive wheel (not shown) to the hub assembly 30.

As further illustrated in FIGS. 1 and 2, an intermediate component, such as a brake plate 40, is sandwiched between mounting surface 39 of the mounting flange 38 and the mounting surface 27 of the hub mounting portion 26. The brake plate 40 is in the form of a plate with substantially parallel axially outer surfaces 41₁ and 41₂ engaging the mounting flange 38 of the hub assembly 30 and the hub mounting portion 26 of the axle tube 20, respectively.

During manufacturing the drive axle assembly 10 according to the first exemplary embodiment of the present invention, in order to provide (achieve) a predetermined toe angle β of the drive wheel, the mounting surface 27 of the hub mounting portion 26 of the axle tube 20 is formed, such as taper milled or machined, at an angle β to a vertical plane orthogonal to the longitudinal central axis 21. The angle β is substantially equal to a predetermined toe angle of the wheel of the drive axle assembly 10. Subsequently, when the hub assembly 30 is mounted to the hub mounting portion 26 of the axle tube 20, the central axis 33 of the hub assembly 30 is oriented at the angle β to the central axis 21 of the axle tube 20, thus providing the predetermined toe angle β of the drive wheel. The predetermined toe angle β is determined by the vehicle manufacturer depending upon structural parameter and desired dynamic characteristic of the vehicle in accordance with vehicle manufacturer's specifications determine.

It will be appreciated that the present invention may provide either toe-in or toe-out of the drive wheels of the drive axle assembly 10. Specifically, if the central axis 33 of the hub assembly 30 extends in front of the longitudinal central axis 21 of the axle tube 20, then the toe-in of the drive wheels is provided (shown in FIGS. 1 and 2). Similarly, if the central axis 33 of the hub assembly 30 extends behind the longitudinal central axis 21 of the axle tube 20, then the toe-out of the drive wheels is provided.

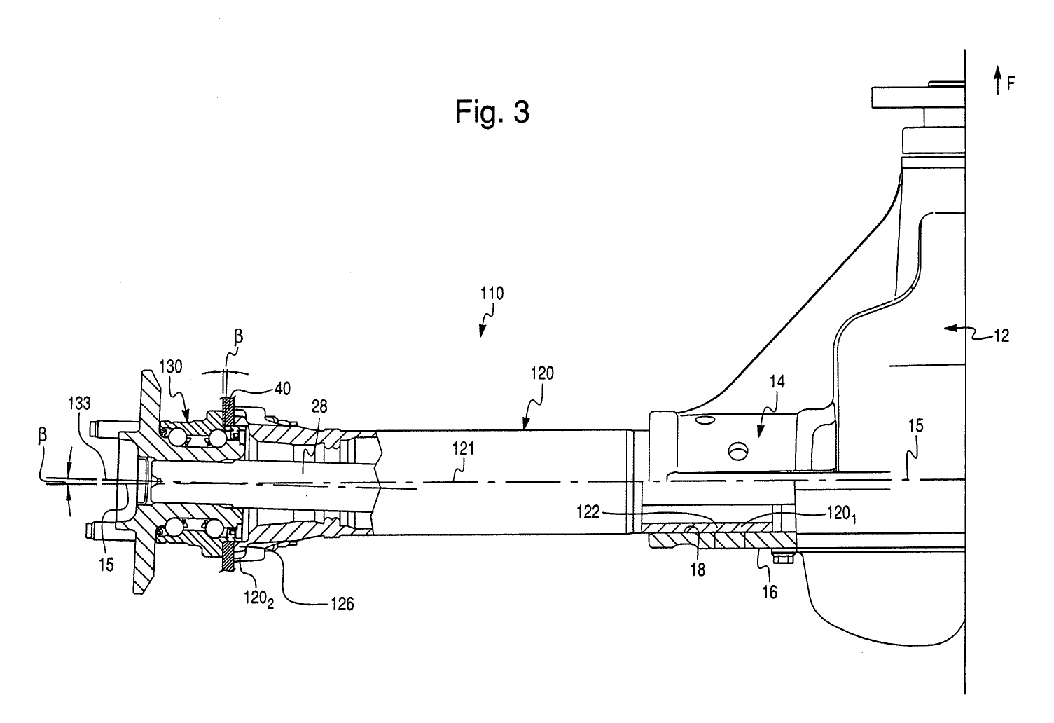

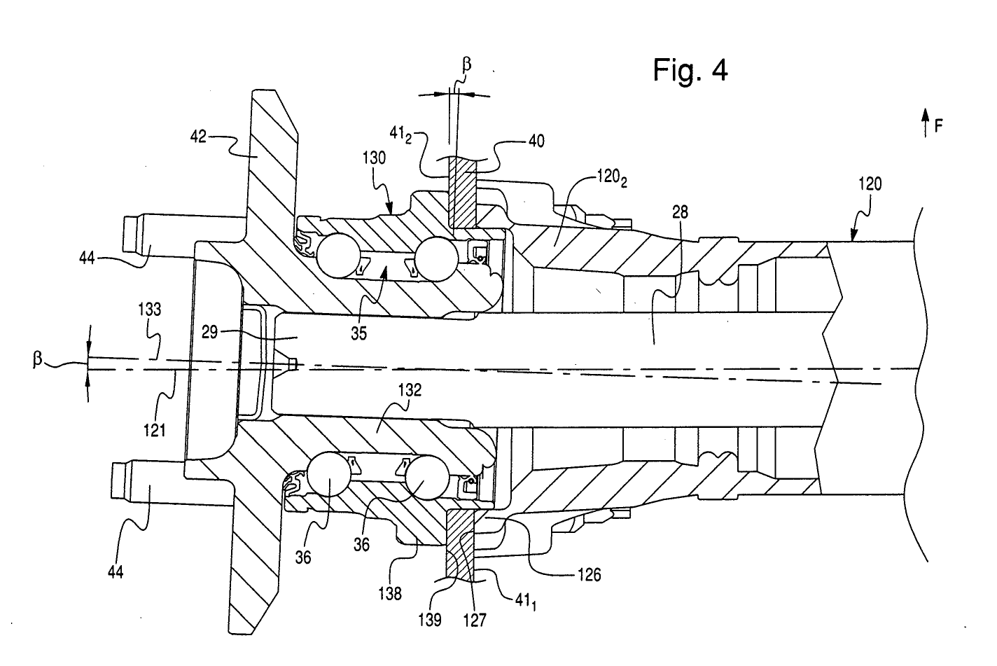

FIGS. 3 and 4 illustrate a second exemplary embodiment of a drive axle assembly, generally depicted by the reference character 110. Components, which are unchanged from the previous exemplary embodiments of the present invention are labeled with the same reference characters. Components, which function in the same way as in the first exemplary embodiment of the present invention depicted in FIGS. 1 and 2 are designated by the same reference numerals to which 100 has been added, sometimes without being described in detail since similarities between the corresponding parts in the two embodiments will be readily perceived by the reader. It should be noted that the drive axle assembly 110 is illustrated in FIGS. 3 and 4 in an assembled condition with no vertical or horizontal load, such as vehicle weight, traction force, etc., applied thereto.

The drive axle assembly 110 according to the second exemplary embodiment of the present invention comprises a carrier member 12 defining a transverse axis 15 and provided with a pair of trunnions 14 (only one trunnion is shown in FIG. 3) axially outwardly extending from the carrier member 12 along the transverse axis 15.

The drive axle assembly 110 also comprises a pair of hollow axle tubes 120 (only one axle tubes is shown in FIG. 3) axially outwardly extending from the trunnions 14 of the carrier member 12. Each of the axle tube 120 has a central axis 121 extending between inner and outer ends, 120₁ and 120₂, respectively, of the axle tube 120. In the second exemplary embodiment of the present invention, the central axis 121 of the axle tube 120 is substantially coaxial to the transverse axis 15 of the carrier member 12. The drive axle assembly 110 further comprises a pair of axle shafts 28 (only one axle shaft is shown in FIG. 3) axially outwardly extending from the carrier member 12 and through the axle tubes 120, and a pair of hub assemblies 130 (only one shown in FIG. 3) each coupled to the outer end 120₂ of the corresponding axle tube 120. Each of the axle tubes 120 is coupled with the corresponding annular trunnion 14 by any appropriate means known in the art. The axle shafts 28 may then be inserted through the axle tubes 120 into driving engagement with side gears (not shown) of the differential mechanism housed in the carrier member 12. Moreover, the axle tube 120 has a carrier mounting portion 122 at the inner end 120₁ thereof coupled to the trunnion 14 of the carrier member 12, and a hub mounting portion 126 at the outer end 120₂ thereof coupled to the hub assembly 130. Furthermore, the hub mounting portion 126 of the axle tube 120 has a mounting surface 127 facing the hub assembly 130. The mounting surface 127 of the hub mounting portion 126 of the axle tube 120 is formed (machined) to be substantially orthogonal to the central axis 121 of the axle tube 120.

The hub assembly 130 includes a rotatable hub member 132 drivingly coupled to an outboard end 29 of the axle shaft 28, and a non-rotatable (stationary) hub member 134 non-rotatably coupled to the hub mounting portion 126 of the axle tube 120. The rotatable hub member 132 is rotatably supported by the non-rotatable hub member 134 through a bearing assembly 35 for rotation about a central axis 133 of the hub assemblies 130. The bearing assembly 35 includes an inner race defined by the rotatable hub member 132 of the hub assemblies 130, an outer race defined by the non-rotatable hub member 134 thereof, and a plurality of rolling elements 36. The non-rotatable hub member 134 of the hub assemblies 130 is further provided with a mounting flange 138. The mounting flange 138 has a mounting surface 139 facing the mounting surface 127 of the hub mounting portion 126 of the axle tube 120.

As further illustrated in FIGS. 3 and 4, an intermediate component, such as a brake plate 40, is sandwiched between mounting surface 139 of the mounting flange 138 and the mounting surface 127 of the hub mounting portion 126. The brake plate 40 is in the form of a plate with substantially parallel axially outer surfaces 41₁ and 41₂ engaging the mounting flange 138 of the hub assembly 130 and the hub mounting portion 126 of the axle tube 120, respectively.

During manufacturing the drive axle assembly 110 according to the second exemplary embodiment of the present invention, in order to provide (achieve) a predetermined toe angle β of the drive wheel, the mounting surface 139 of the mounting flange 138 of the hub assemblies 130 is formed, such as by taper milling or machining, at an angle β to a vertical plane orthogonal to the central axis 133 of the hub assemblies 130. The angle β is substantially equal to a predetermined toe angle of the wheel of the drive axle assembly 110. Subsequently, when the hub assembly 130 is mounted to the hub mounting portion 126 of the axle tube 120, the central axis 133 of the hub assembly 130 is oriented at the angle β to the longitudinal central axis 121, thus providing the predetermined toe angle β of the drive wheel. The predetermined toe angle β is determined by the vehicle manufacturer depending upon structural parameter and desired dynamic characteristic of the vehicle in accordance with vehicle manufacturer's specifications determine.

It will be appreciated that the present invention may provide either toe-in or toe-out of the drive wheels of the drive axle assembly 110. Specifically, if the central axis 133 of the hub assembly 30 extends in front of the longitudinal central axis 121 of the axle tube 20, then the toe-in of the drive wheels is provided (shown in FIGS. 3 and 4). Similarly, if the central axis 133 of the hub assembly 130 extends behind the longitudinal central axis 121 of the axle tube 120, then the toe-out of the drive wheels is provided.

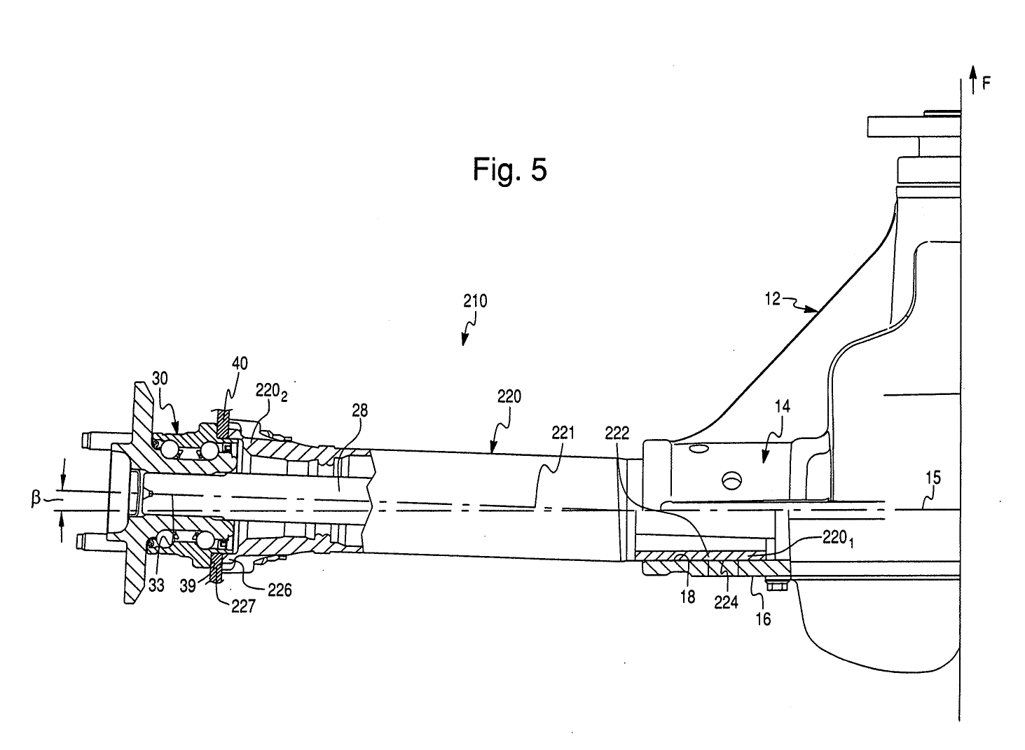

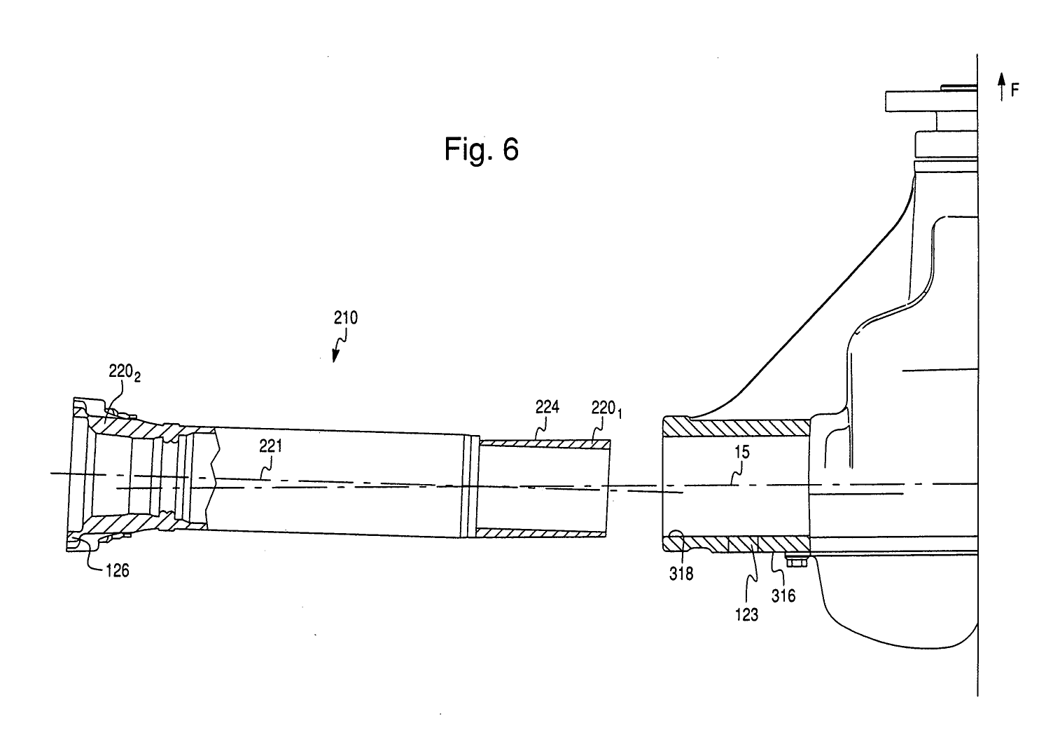

FIGS. 5 and 6 illustrate a third exemplary embodiment of a drive axle assembly, generally depicted by the reference character 210. Components, which are unchanged from the previous exemplary embodiments of the present invention are labeled with the same reference characters. Components, which function in the same way as in the first exemplary embodiment of the present invention depicted in FIGS. 1 and 2 are designated by the same reference numerals to which 200 has been added, sometimes without being described in detail since similarities between the corresponding parts in the two embodiments will be readily perceived by the reader. It should be noted that the drive axle assembly 210 is illustrated in FIG. 5 in an assembled condition with no vertical or horizontal load, such as vehicle weight, traction force, etc., applied thereto.

The drive axle assembly 210 according to the third exemplary embodiment of the present invention comprises a carrier member 12 defining a transverse axis 15 and provided with a pair of annular trunnions 14 (only one trunnion is shown in FIG. 5) axially outwardly extending from the carrier member 12 along the transverse axis 15. Each of the trunnions 14 has a substantially cylindrical inner peripheral surface 18 defining a mounting bore therein substantially coaxial to the transverse axis 15. Preferably, the each of the trunnions 14 has a generally cylindrical outer peripheral surface 16 also substantially coaxial to the transverse axis 15.

The drive axle assembly 210 also comprises a pair of hollow axle tubes 220 (only one axle tubes is shown in FIG. 5) axially outwardly extending from the trunnions 14 of the carrier member 12. The axle tube 220 has a central axis 221 extending between inner and outer ends, 220₁ and 220₂, respectively, of the axle tube 220. Preferably, the axle tube 220 has a substantially cylindrical inner peripheral surface 225 defining the central axis 221 thereof. In the third exemplary embodiment of the present invention, the central axis 221 of the axle tube 220 is oblique to the transverse axis 15 of the carrier member 12.

The drive axle assembly 210 further comprises a pair of axle shafts 28 (only one axle shaft is shown in FIG. 5) axially outwardly extending from the carrier member 12 and through the axle tubes 220, and a pair of hub assemblies 30 (only one shown in FIG. 5) each coupled to the outer end 220₂ of the corresponding axle tube 220. Each of the axle tubes 220 is coupled with the corresponding trunnion 14 by any appropriate means known in the art, such as by press-fitting. The axle shafts 28 may then be inserted through the axle tubes 320 into driving engagement with side gears (not shown) of the differential mechanism housed in the carrier member 12.

Moreover, the axle tube 220 has a carrier mounting portion 222 at the inner end 220₁ thereof coupled to the trunnion 14 of the carrier member 12, and a hub mounting portion 226 at the outer end 220₂ thereof coupled to the hub assembly 230. Furthermore, the hub mounting portion 226 of the axle tube 220 has a mounting surface 227 facing the hub assembly 30. The mounting surface 227 of the hub mounting portion 226 of the axle tube 220 is formed (machined) to be substantially orthogonal to the central axis 221 of the axle tube 220. Similarly, a mounting flange 38 of the non-rotatable hub member 34 of the hub assemblies 30 has a mounting surface 39 facing the mounting surface 227 of the hub mounting portion 226 of the axle tube 220. The mounting surface 39 is formed (machined) to be substantially orthogonal to a central axis 33 of the hub assembly 30. In other words, the central axis 33 of the hub assembly 30 is substantially coaxial with the central axis 221 of the axle tube 220.

The carrier mounting portion 222 of the axle tube 220 has a continuous outer peripheral surface 224 complementary to the inner peripheral surface 18 of the corresponding annular trunnion 14 of the carrier member 12. Preferably, the outer surface 224 of the carrier mounting portion 222 of the axle tube 220 is substantially cylindrical and defines a central axis 221₁ thereof, as shown in FIG. 6. In assembled condition, the carrier mounting portion 222 of the axle tube 220 is mounted to the mounting bore 18 of the trunnion 14 so that the outer surface 224 of the carrier mounting portion 222 engages the complementary inner surface 18 of the trunnion 14.

In order to provide (obtain) a predetermined toe angle β of the drive wheel according to the third exemplary embodiment of the present invention, the outer surface 224 of the carrier mounting portion 222 of the axle tube 220 is formed, such as by taper milling or machining, so that the central axis 221₁ thereof is oriented at the predetermined angle β to the central axis 221 of the axle tube 220 in a horizontal plane including the central axis 221 of the axle tube 220. Subsequently, when the carrier mounting portion 222 of the axle tube 220 is mounted to the mounting bore 18 of the trunnion 14 so that the central axis 221, of the carrier mounting portion 222 of the axle tube 220 is substantially coaxial to the transverse axis 15 of the carrier member 12, a central axis 33 of the hub assembly 30 is oriented at the angle β to the transverse axis 15, thus providing the predetermined toe angle β of the drive wheel.

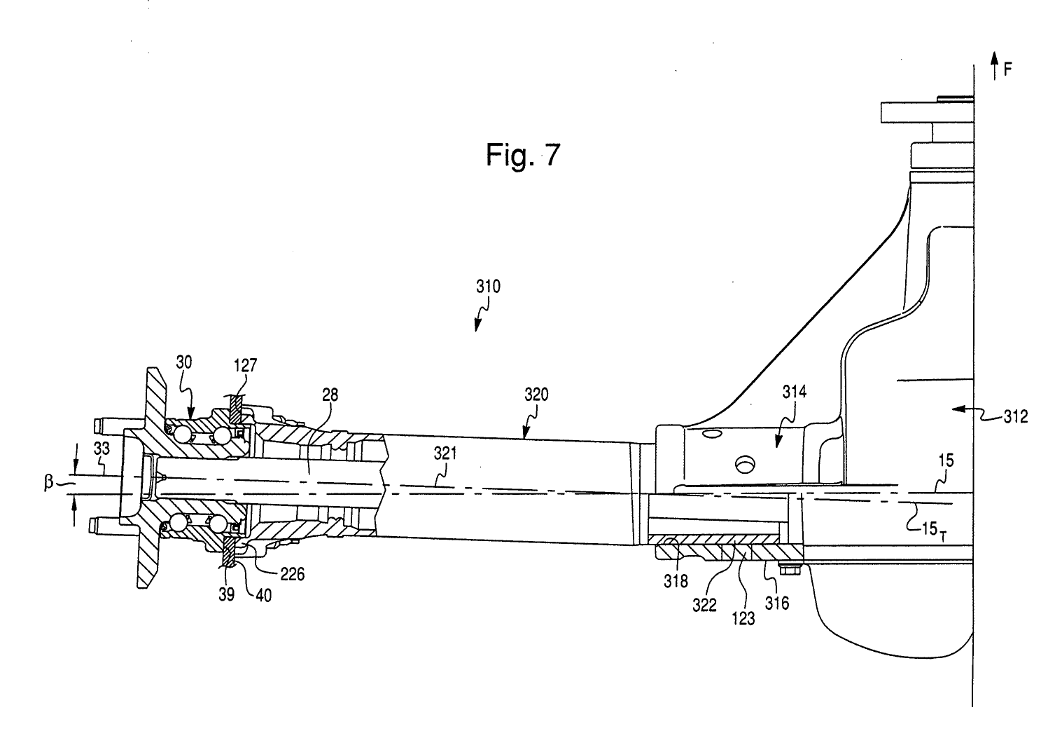

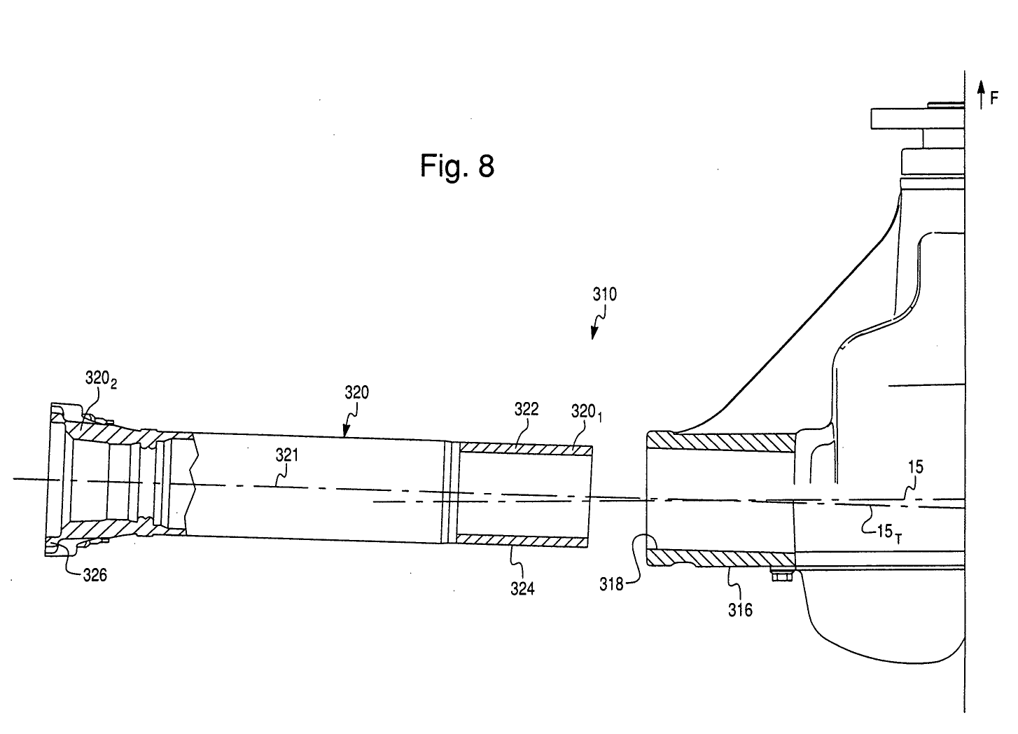

FIGS. 7 and 8 illustrate a fourth exemplary embodiment of a drive axle assembly, generally depicted by the reference character 310. Components, which are unchanged from the previous exemplary embodiments of the present invention are labeled with the same reference characters. Components, which function in the same way as in the first exemplary embodiment of the present invention depicted in FIGS. 1 and 2 are designated by the same reference numerals to which 300 has been added, sometimes without being described in detail since similarities between the corresponding parts in the two embodiments will be readily perceived by the reader. It should be noted that the drive axle assembly 310 is illustrated in FIG. 7 in an assembled condition with no vertical or horizontal load, such as vehicle weight, traction force, etc., applied thereto.

The drive axle assembly 310 comprises a carrier member 312 defining a transverse axis 315 and provided with a pair of annular trunnions 314 axially outwardly extending from the carrier member 312 along the transverse axis 315. Preferably, the each of the trunnions s 314 has a generally cylindrical outer peripheral surface 316 also substantially coaxial to the transverse axis 315. Moreover, each of the trunnions 314 has a substantially cylindrical inner peripheral surface 318 defining a mounting bore therein having a central axis 315_{T}.

According to the fourth exemplary embodiment of the present invention, the central axis 315_{T} of the inner surface 318 of the trunnion 314 is formed oblique to the transverse axis 315 of the carrier member 312.

The drive axle assembly 310 also comprises a pair of hollow axle tubes 320 (only one axle tubes is shown in FIG. 7) axially outwardly extending from the trunnions 314 of the carrier member 312. The axle tube 320 has a central axis 321 extending between inner and outer ends, 320, and 320₂, respectively, of the axle tube 320. Preferably, the axle tube 220 has a substantially cylindrical inner peripheral surface 225 defining the central axis 221 thereof.

The drive axle assembly 310 further comprises a pair of axle shafts 28 (only one axle shaft is shown in FIG. 7) axially outwardly extending from the carrier member 312 and through the axle tubes 320, and a pair of hub assemblies 30 (only one shown in FIG. 7) each coupled to the outer end 320₂ of the corresponding axle tube 320. Each of the axle tubes 320 is coupled with the corresponding trunnion 314 by any appropriate means known in the art, such as by press-fitting. The axle shafts 28 may then be inserted through the axle tubes 320 into driving engagement with side gears (not shown) of the differential mechanism housed in the carrier member 312.

Moreover, the axle tube 320 has a carrier mounting portion 322 at the inner end 320₁ thereof coupled to the trunnion 314 of the carrier member 312, and a hub mounting portion 326 at the outer end 320₂ thereof coupled to the hub assembly 30. Furthermore, the hub mounting portion 326 of the axle tube 320 has a mounting surface 327 facing the hub assembly 30. The mounting surface 327 of the hub mounting portion 326 of the axle tube 320 is formed (machined) to be substantially orthogonal to the central axis 321 of the axle tube 320. Similarly, a mounting flange 38 of the non-rotatable hub member 34 of the hub assemblies 30 has a mounting surface 39 facing the mounting surface 327 of the hub mounting portion 326 of the axle tube 320. The mounting surface 39 is formed (machined) to be substantially orthogonal to a central axis 33 of the hub assembly 30. In other words, the central axis 33 of the hub assembly 30 is substantially coaxial with the central axis 321 of the axle tube 320.

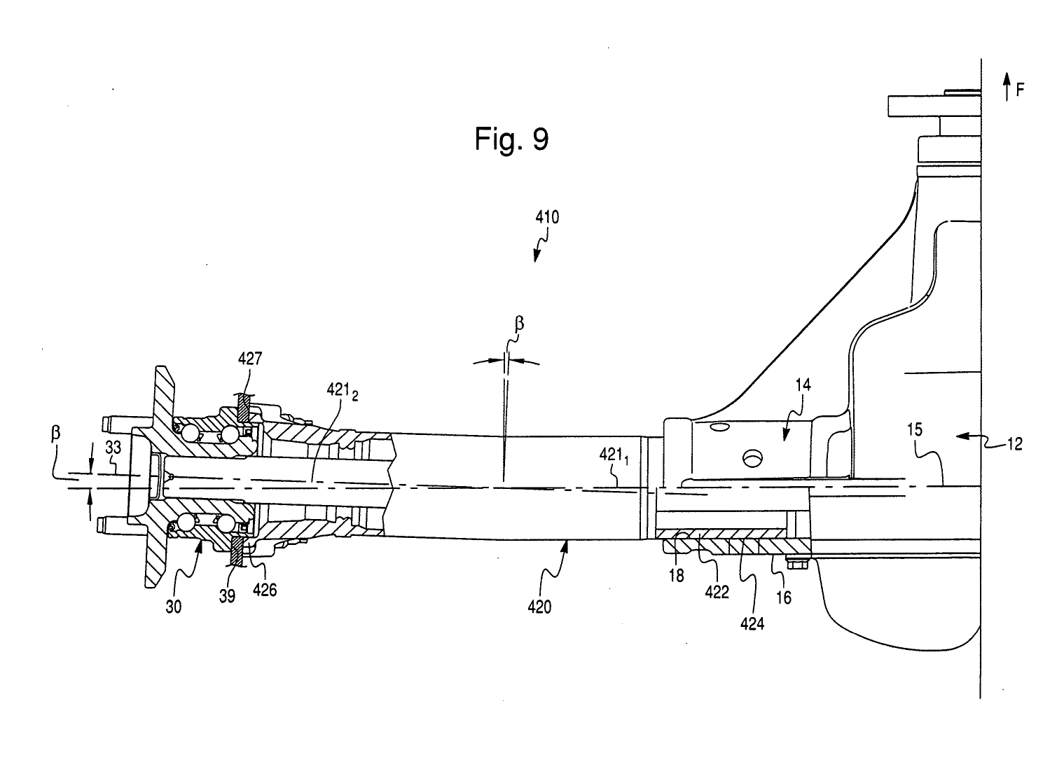

The carrier mounting portion 322 of the axle tube 320 has a continuous outer peripheral surface 324 complementary to the inner peripheral surface 318 of the corresponding annular trunnion 314 of the carrier member 312. Preferably, the outer surface 324 of the carrier mounting portion 322 of the axle tube 320 is substantially cylindrical and coaxial with the central axis 321 of the axle tube 320, as shown in FIG. 9. Alternatively, the outer surface 324 of the carrier mounting portion 322 of the axle tube 320 may be substantially conical. In assembled condition, the carrier mounting portion 322 of the axle tube 320 is mounted to the mounting bore 318 of the trunnion 14 so that the outer surface 324 of the carrier mounting portion 322 engages the complementary inner surface 318 of the trunnion 314.

In order to provide (obtain) a predetermined toe angle β of the drive wheel according to the fourth exemplary embodiment of the present invention, the inner surface 318 of the trunnion 314 of the carrier member 312 is formed, such as by taper milling or machining, so that the central axis 315_{T} thereof is oriented at the predetermined angle β to the transverse axis 315 of the carrier member 312 in a horizontal plane including the transverse axis 315 of the carrier member 312. Subsequently, when the carrier mounting portion 322 of the axle tube 320 is mounted to the mounting bore 318 of the trunnion 314 so that the central axis 221 of the axle tube 220 is substantially coaxial to the transverse axis 315 of the carrier member 312, a central axis 33 of the hub assembly 30 is oriented at the angle β to the transverse axis 315, thus providing the predetermined toe angle β of the drive wheel.

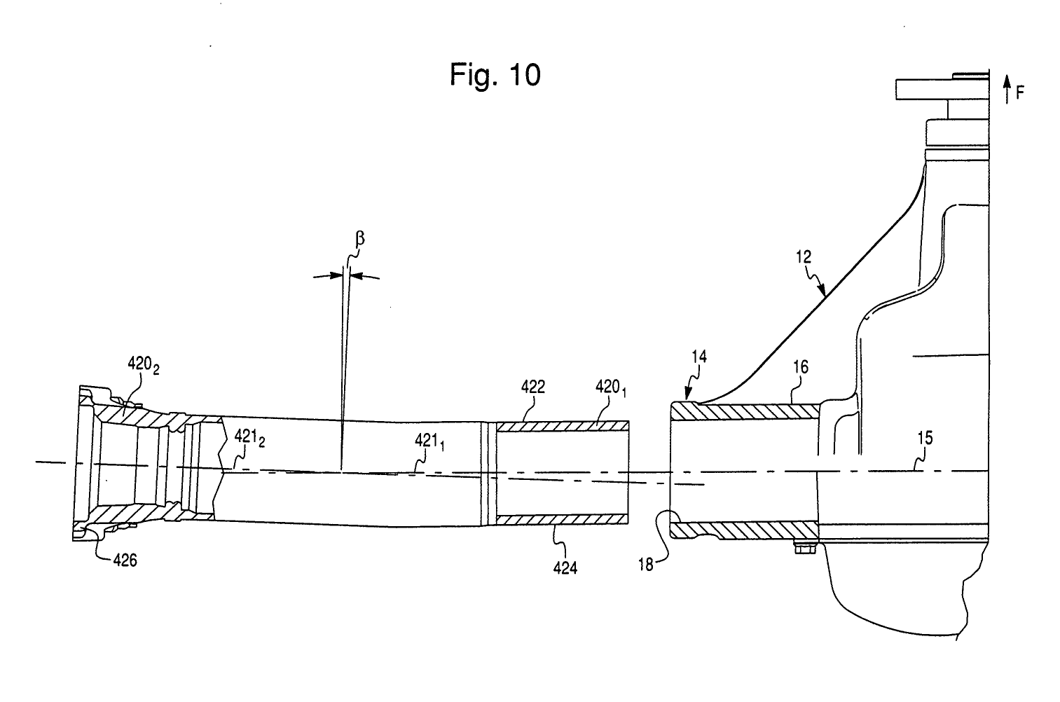

FIGS. 9 and 10 of the drawings illustrate a fifth exemplary embodiment of a drive axle assembly, generally depicted by the reference character 410. Components, which are unchanged from the previous exemplary embodiments of the present invention are labeled with the same reference characters. Components, which function in the same way as in the first exemplary embodiment of the present invention depicted in FIGS. 1 and 2 are designated by the same reference numerals to which 400 has been added, sometimes without being described in detail since similarities between the corresponding parts in the two embodiments will be readily perceived by the reader. It should be noted that the drive axle assembly 310 is illustrated in FIG. 9 in an assembled condition with no vertical or horizontal load, such as vehicle weight, traction force, etc., applied thereto.

The drive axle assembly 410 according to the fifth exemplary embodiment of the present invention comprises a carrier member 12 defining a transverse axis 15 and provided with a pair of annular trunnions (or mounting sleeves) 14 (only one trunnion is shown in FIG. 9) axially outwardly extending from the carrier member 12 along the transverse axis 15. Each of the trunnions 14 has a substantially cylindrical inner peripheral surface 18 defining a mounting bore therein substantially coaxial to the transverse axis 15.

The drive axle assembly 410 also comprises a pair of hollow axle tubes 420 (only one axle tubes is shown in FIG. 9) axially outwardly extending from the trunnions 14 of the carrier member 12. The axle tube 420 has inner and outer ends, 420₁ and 420₂, respectively. The inner end 420₁ of the axle tube 420 defines a first central axis 421₁, while the outer end 420₂ thereof defines a second central axis 421₂ (as shown in FIG. 10). Moreover, the axle tube 420 according to the fifth exemplary embodiment is non-linear (or bent). Specifically, the first axis 421₁ of the inner end 420₁ of the axle tube 420 intersects the second axis 421₂ of the outer end 420₂ thereof at an angle β (as shown in FIG. 10). The drive axle assembly 410 further comprises a pair of axle shafts 28 (only one axle shaft is shown in FIG. 9) axially outwardly extending from the carrier member 12 and through the axle tubes 420, and a pair of hub assemblies 30 (only one shown in FIG. 9) each coupled to the outer end 420₂ of the corresponding axle tube 420. Each of the axle tubes 420 is coupled with the corresponding trunnion 14 by any appropriate means known in the art, such as by press-fitting. The axle shafts 28 may then be inserted through the axle tubes 420 into driving engagement with side gears (not shown) of the differential mechanism housed in the carrier member 12.

The carrier mounting portion 422 of the axle tube 420 has a continuous outer peripheral surface 424 complementary to the inner peripheral surface 18 of the corresponding annular trunnion 14 of the carrier member 12. Preferably, the outer surface 424 of the carrier mounting portion 422 of the axle tube 420 is substantially cylindrical and is formed substantially coaxially to the first central axis 421₁ thereof, as shown in FIG. 9. In assembled condition, the tube mounting portion 422 of the axle tube 420 is mounted to the mounting bore 18 of the trunnion 14 so that the outer surface 424 of the carrier mounting portion 422 engages the complementary inner surface 18 of the trunnion 14.

Moreover, the axle tube 420 has a carrier mounting portion 422 at the inner end 420₁ thereof coupled to the trunnion 14 of the carrier member 12, and a hub mounting portion 426 at the outer end 420₂ thereof coupled to the hub assembly 30. Furthermore, the hub mounting portion 426 of the axle tube 420 has a mounting surface 427 facing the hub assembly 30. The mounting surface 447 of the hub mounting portion 426 of the axle tube 420 is formed (machined) to be substantially orthogonal to the second axis 420₂ of the axle tube 420.

Similarly, a mounting flange 38 of the non-rotatable hub member 34 of the hub assemblies 30 has a mounting surface 39 facing the mounting surface 427 of the hub mounting portion 426 of the axle tube 420. The mounting surface 39 is formed (machined) to be substantially orthogonal to a central axis 33 of the hub assembly 30. In other words, the central axis 33 of the hub assembly 30 is substantially coaxial with the second axis 420₂ of the axle tube 420.

In order to provide (obtain) a predetermined toe angle of the drive wheel according to the fifth exemplary embodiment of the present invention, the axle tube 420 is bent at an angle β. The angle β is substantially equal to a predetermined toe angle of the wheel of the drive axle assembly 410. Preferably, the axle tube 420 is bent somewhere between the carrier mounting portion 422 and the hub mounting portion 426 thereof by any appropriate means known in the art. Subsequently, during the assembling (manufacturing) of the drive axle assembly 410, the carrier mounting portion 422 of the axle tube 420 is mounted to the mounting bore 18 of the trunnion 14 so that the first and second central axes 421₁ and 420₂ are oriented in a horizontal plane. As a result, the central axis 33 of the hub assembly 30 is oriented at the angle β to the transverse axis 15, thus providing the predetermined toe-in angle β of the drive wheel.

Therefore, the present invention provides a novel drive axle assembly and method for assembling thereof, which provides a predetermined toe angle of drive wheels of a motor vehicle in a way that is accurate, simple, cost effective, and substantially reduces time and labor expenses.

The foregoing description of the preferred embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A drive axle assembly comprising:
an axle tube having a central axis and a tube mounting surface adjacent an outer end of said axle tube; and
a hub assembly having a central axis and including a rotatable hub member and a non-rotatable hub member, said non-rotatable hub member having a hub mounting surface engaging said tube mounting surface of said axle tube;
wherein one of said tube mounting surface and said hub mounting surface oriented at an angle to the corresponding central axis substantially equal to a predetermined toe angle of a wheel of said drive axle assembly.

2. The drive axle assembly as defined in claim 1, further comprising a brake plate sandwiched between said mounting surfaces of said non-rotatable hub member and said outer end of said axle tube.

3. The drive axle assembly as defined in claim 2, wherein said brake plate is in the form of a plate having substantially parallel axially spaced outer surfaces one engaging said hub mounting surface and the other engaging said tube mounting surface.

4. The drive axle assembly as defined in claim 1, wherein said tube mounting surface is oriented at said predetermined toe angle to said central axis of said axle tube and said hub mounting surface is substantially orthogonal to said central axis of said hub assembly.

5. The drive axle assembly as defined in claim 1, wherein said hub mounting surface is oriented at said predetermined toe angle to said central axis of said hub assembly and said tube mounting surface is substantially orthogonal to said central axis of said axle tube.

6. The drive axle assembly as defined in claim 1, wherein said one of said angle oriented tube mounting surface and said hub mounting surface is formed by one of taper milling and machining.

7. The drive axle assembly as defined in claim 1, further comprising a hollow carrier member mounted to an inner end of said axle tube so that said central axis of said axle tube is coaxial to a transverse axis of said carrier member.

8. The drive axle assembly as defined in claim 1, wherein said predetermined angle is located in a horizontal plane including said central axis of said axle tube.

9. The drive axle assembly as defined in claim 1, further comprising an axle shaft extending through said axle tube and drivingly coupled to said rotatable hub member.

10. A method for providing a predetermined toe angle of a wheel of a drive axle assembly, said method comprising the steps of:
providing an axle tube having a central axis and a tube mounting surface adjacent an outer end of said axle tube;
providing a hub assembly having a central axis and including a rotatable hub member and a non-rotatable hub member having a hub mounting surface;
determining a predetermined toe angle of a wheel of said drive axle assembly driven by said rotatable hub member of said hub assembly;
forming one of said tube mounting surface and said hub mounting surface so as to be oriented at an angle to the corresponding central axis substantially equal to said predetermined toe angle of said wheel;
attaching said non-rotatable hub member to said outer end of said axle tube by connecting said tube mounting surface to said hub mounting surface.

11. The method as defined in claim 10, wherein the step of forming one of said tube mounting surface and said hub mounting surface includes the step of forming said tube mounting surface oriented at said predetermined toe angle to said central axis of said axle tube and forming said hub mounting surface oriented substantially orthogonally to said central axis of said hub assembly.

12. The method as defined in claim 10, wherein the step of forming one of said tube mounting surface and said hub mounting surface includes the step of forming said hub mounting surface oriented at said predetermined toe angle to said central axis of said hub assembly and forming said tube mounting surface oriented substantially orthogonallt to said central axis of said axle tube.

13. The method as defined in claim 10, wherein the step of forming one of said tube mounting surface and said hub mounting surface includes the step of forming one of said tube mounting surface and said hub mounting surface by one of taper milling and machining.

14. The method as defined in claim 10, wherein said predetermined toe angle is located in a horizontal plane including said central axis of said axle tube.

15. The method as defined in claim 10, further comprising the steps of:
providing a hollow carrier member having a transverse axis;
mounting to an inner end of said axle tube to said carrier member so that said central axis of said axle tube is coaxial to said transverse axis of said carrier member.

16. The method as defined in claim 10, wherein the step of attaching said non-rotatable hub member to said outer end of said axle tube includes the step of orienting said non-rotatable hub member to said outer end of said axle tube so that said predetermined angle is located in a horizontal plane including said central axis of said axle tube.

17. A drive axle assembly comprising:
a hollow carrier member having a transverse axis and a trunnion having a continuous inner surface defining a central axis thereof; and
an axle tube having a central axis and a carrier mounting portion provided at an inner end of said axle tube, said carrier mounting portion having a continuous outer surface defining a central axis thereof;
said outer surface of said carrier mounting portion engaging said inner surface of said trunnion;
one of said outer surface and said inner surface formed so that said central axis of said axle tube intersecting said transverse axis of said carrier member at an angle substantially equal to a predetermined toe angle of a wheel of said drive axle assembly.

18. The drive axle assembly as defined in claim 17, wherein said outer surface of said carrier mounting portion is formed so that said central axis thereof is oriented at said predetermined toe angle to said central axis of said axle tube.

19. The drive axle assembly as defined in claim 18, wherein said inner surface of said trunnion is formed so that said central axis thereof is oriented substantially coaxially to said transverse axis of said carrier member.

20. The drive axle assembly as defined in claim 17, wherein said inner surface of said trunnion is formed so that said central axis thereof is oriented at said predetermined toe angle to said transverse axis of said carrier member.

21. The drive axle assembly as defined in claim 20, wherein said outer surface of said carrier mounting portion is formed so that said central axis thereof is oriented substantially coaxially to said central axis of said axle tube.

22. The drive axle assembly as defined in claim 17, wherein said predetermined toe angle is located in a horizontal plane including said central axis of said axle tube.

23. The drive axle assembly as defined in claim 17, further comprising a hub assembly having a central axis and including a rotatable hub member and a non-rotatable hub member, said hub assembly mounted to an outer end of said axle tube so that said central axis of said hub assembly is substantially coaxial to said central axis of said axle tube.

24. The drive axle assembly as defined in claim 17, wherein said outer surface of said carrier mounting portion is complementary to said inner surface of said trunnion.

25. A method for providing a predetermined toe angle of a wheel of a drive axle assembly, said method comprising the steps of:
providing a hollow carrier member having a transverse axis and a trunnion:
providing an axle tube having a central axis and a carrier mounting portion provided at an inner end thereof;
determining a predetermined toe angle of a wheel of said drive axle assembly; and
coupling said carrier mounting portion to said trunnion so that said central axis of said axle tube intersecting said transverse axis of said carrier member at said predetermined toe angle.

26. The method as defined in claim 25, wherein the step of coupling said carrier mounting portion to said trunnion includes the steps forming a continuous inner surface of said trunnion defining a central axis thereof and a continuous outer surface of said carrier mounting portion defining a central axis thereof, and engaging said inner surface of said trunnion with said outer surface of said carrier mounting portion.

27. The method as defined in claim 26, wherein said outer surface of said carrier mounting portion is formed to be complementary to said inner surface of said trunnion.

28. The method as defined in claim 26, wherein the step of forming said inner surface and said outer surface is performed so that one of said central axis of inner surface and said central axis of said outer surface being oriented at said predetermined toe angle to the corresponding one of said transverse axis of said carrier member and said central axis of said axle tube.

29. The method as defined in claim 28, wherein the step of forming said inner surface and said outer surface includes the step of forming said inner surface so that said central axis of said inner surface is oriented at said predetermined toe angle to said transverse axis of said carrier member.

30. The method as defined in claim 29, wherein the step of forming said inner surface and said outer surface further includes the step of forming said outer surface so that said central axis of said outer surface is substantially coaxial to said central axis of said axle tube.

31. The method as defined in claim 28, wherein the step of forming said inner surface and said outer surface includes the step of forming said outer surface so that said central axis of said outer surface is oriented at said predetermined toe angle to said central axis of said axle tube.

32. The method as defined in claim 31, wherein the step of forming said inner surface and said outer surface further includes the step of forming said inner surface so that said central axis of said inner surface is substantially coaxial to said transverse axis of said carrier member.

33. The method as defined in claim 26, wherein the step of forming said inner surface of said trunnion and said outer surface of said carrier mounting portion includes one of taper milling and machining.

34. The method as defined in claim 25, wherein said carrier mounting portion of said axle tube is coupled to said trunnion of said carrier member so that said predetermined toe angle is located in a horizontal plane including said central axis of said axle tube.

35. The method as defined in claim 25, further comprising the steps of:
providing a hub assembly having a central axis and including a rotatable hub member and a non-rotatable hub member; and
mounting said hub assembly to an outer end of said axle tube so that said central axis of said hub assembly is substantially coaxial to said central axis of said axle tube.

36. A drive axle assembly comprising:
an axle tube having inner and outer ends;
a hollow carrier member mounted to said inner end of said axle tube; and
a hub assembly mounted to said outer end of said axle tube for rotatably supporting a wheel;
said axle tube being non-linear so that a central axis of said outer end of said axle tube intersecting a central axis of said inner end thereof at an angle substantially equal to a predetermined toe angle of said wheel.

37. The drive axle assembly as defined in claim 36, wherein said predetermined angle is located in a horizontal plane including both said central axes of said inner end and outer end of said axle tube.

38. The drive axle assembly as defined in claim 36, wherein said carrier member has a transverse axis; and wherein said central axis of said inner end of said axle tube is substantially coaxial to said transverse axis of said carrier member.

39. The drive axle assembly as defined in claim 36, wherein said hub assembly has a central axis; and wherein said central axis of said outer end of said axle tube is substantially coaxial to said central axis of said hub assembly.

40. A method for providing a predetermined toe angle of a wheel of a drive axle assembly, said method comprising the steps of:
providing an axle tube having inner and outer ends;.
determining a predetermined toe angle of a wheel of said drive axle assembly;
bending said axle tube so that a central axis of said outer end intersecting a central axis of said inner end at an angle substantially equal to a predetermined toe angle of said wheel;
providing a hollow carrier member having a transverse axis; and
mounting said inner end of said axle tube to said carrier member.

41. The method as defined in claim 40, wherein said inner end of said axle tube is mounted to said carrier member so that said central axis of said inner end is substantially coaxial to a transverse axis of said carrier member.

42. The method as defined in claim 40, further including the steps of:
providing a hub assembly having a central axis; and
mounting said outer end of said axle tube to said hub assembly.

43. The method as defined in claim 42, wherein said outer end of said axle tube is mounted to said hub assembly so that said central axis of said outer end is substantially coaxial to said central axis of said hub assembly.

44. The method as defined in claim 40, wherein said outer end of said axle tube is coupled to said carrier member so that said predetermined toe angle is located in a horizontal plane including said central axes of said inner and outer ends of said axle tube.
